(19) United States
(12) Patent Application Publication
(10) Pub. No.: US 2025/0156633 A1
(43) Pub. Date: May 15, 2025

(54) DATA DRIFT DETECTION FOR UNSTRUCTURED TEXTS VIA DEEP LEARNING AUTOENCODERS

(71) Applicant: GE Precision Healthcare LLC, Waukesha, WI (US)

(72) Inventors: Hrithik Auchar, Bangalore (IN); Ananya Sahoo, Bangalore (IN)

(21) Appl. No.: 18/508,782

(22) Filed: Nov. 14, 2023

(51) Int. Cl. G06F 40/20; G06N 20/00

(52) U.S. Cl. CPC G06F 40/20; G06N 20/00

(57) ABSTRACT

Systems/techniques that facilitate data drift detection for unstructured texts via deep learning autoencoders are provided. In various embodiments, a system can access a pre-trained natural language model and a set of unstructured texts on which the model is to be executed. In various aspects, the system can determine, via execution of a deep learning autoencoder, how different a first set of reconstruction errors associated with the set of unstructured texts are from a second set of reconstruction errors associated with a set of training unstructured texts on which the pre-trained natural language model was trained. In various instances, the system can generate, in response to a determination that the first and second sets of reconstruction errors differ by more than a threshold margin, a first alert indicating that data drift has occurred and that the model is thereby unable to confidently analyze the set of unstructured texts.

### TECHNICAL FIELD

The subject disclosure relates generally to natural language processing, and more specifically to data drift detection for unstructured texts via deep learning autoencoders.

### BACKGROUND

A natural language processing model can be trained to perform an inferencing task on unstructured texts. For any given unstructured text, it can be desirable to determine whether or not the natural language processing model can confidently analyze the given unstructured text. Unfortunately, existing techniques facilitate such confidence determination ineffectively.

Accordingly, systems or techniques that can address one or more of these technical problems can be desirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate data drift detection for unstructured texts via deep learning autoencoders are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a pre-trained natural language model and a set of unstructured text reports on which the pre-trained natural language model is to be executed. In various aspects, the computer-executable components can comprise a drift component that can determine, via execution of a deep learning autoencoder, how different a first set of reconstruction errors associated with the set of unstructured text reports are from a second set of reconstruction errors associated with a set of training unstructured text reports on which the pre-trained natural language model was trained. In various instances, the computer-executable components can comprise a result component that can generate, in response to a determination that the first set of reconstruction errors differ from the second set of reconstruction errors by more than a threshold margin, a first alert indicating that data drift has occurred and that the pre-trained natural language model is thereby unable to confidently analyze the set of unstructured text reports.

According to one or more embodiments, a computer-implemented method is provided. In various embodiments, the computer-implemented method can comprise accessing, by a device operatively coupled to a processor, a pre-trained natural language model and a set of unstructured text reports on which the pre-trained natural language model is to be executed. In various aspects, the computer-implemented method can comprise determining, by the device and via execution of a deep learning autoencoder, how different a first set of reconstruction errors associated with the set of unstructured text reports are from a second set of reconstruction errors associated with a set of training unstructured text reports on which the pre-trained natural language model was trained. In various instances, the computer-implemented method can comprise generating, by the device and in response to a determination that the first set of reconstruction errors differ from the second set of reconstruction errors by more than a threshold margin, a first alert indicating that data drift has occurred and that the pre-trained natural language model is thereby unable to confidently analyze the set of unstructured text reports.

According to one or more embodiments, a computer program product for facilitating data drift detection for unstructured texts via deep learning autoencoders is provided. In various embodiments, the computer program product can comprise a non-transitory computer-readable memory having program instructions embodied therewith. In various aspects, the program instructions can be executable by a processor to cause the processor to access a pre-trained clinical natural language model and a set of unstructured clinical text reports on which the pre-trained clinical natural language model is to be executed. In various instances, the program instructions can be further executable to cause the processor to determine, via execution of a deep learning autoencoder, how different a first set of reconstruction errors associated with the set of unstructured clinical text reports are from a second set of reconstruction errors associated with a set of training unstructured clinical text reports on which the pre-trained clinical natural language model was trained. In various cases, the program instructions can be further executable to cause the processor to generate, in response to a determination that the first set of reconstruction errors differ from the second set of reconstruction errors by more than a threshold margin, a first alert indicating that data drift has occurred and that the pre-trained clinical natural language model is thereby unable to confidently analyze the set of unstructured clinical text reports.

### DESCRIPTION OF THE DRAWINGS

FIG. 1 illustrates a block diagram of an example, non-limiting system that facilitates data drift detection for unstructured texts via deep learning autoencoders in accordance with one or more embodiments described herein.

FIG. 2 illustrates a block diagram of an example, non-limiting system including a deep learning autoencoder and a data drift determination that facilitates data drift detection for unstructured texts via deep learning autoencoders in accordance with one or more embodiments described herein.

FIGS. 3-5 illustrate example, non-limiting block diagrams showing how a deep learning autoencoder can be leveraged to make a data drift determination in accordance with one or more embodiments described herein.

FIG. 6 illustrates a block diagram of an example, non-limiting system including a drift alert that facilitates data drift detection for unstructured texts via deep learning autoencoders in accordance with one or more embodiments described herein.

FIG. 7 illustrates a block diagram of an example, non-limiting system including a training component that facilitates data drift detection for unstructured texts via deep learning autoencoders in accordance with one or more embodiments described herein.

FIG. 8 illustrates an example, non-limiting block diagram showing how a deep learning autoencoder can be trained in accordance with one or more embodiments described herein.

FIG. 9 illustrates a flow diagram of an example, non-limiting computer-implemented method that facilitates data drift detection for unstructured texts via deep learning autoencoders in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A natural language processing model (e.g., a deep learning neural network) can be trained (e.g., in supervised fashion, in unsupervised fashion, in reinforcement learning fashion) to perform an inferencing task (e.g., classification, segmentation, regression) on unstructured texts (e.g., on sequences of plain text sentences or natural language sentences). For any given unstructured text, it can be desirable to determine whether or not the natural language processing model can confidently analyze the given unstructured text. After all, if the natural language processing model cannot confidently analyze the given unstructured text, this can indicate that retraining or finetuning of the natural language processing model is warranted. On the other hand, if the natural language processing model can confidently analyze the given unstructured text, this can instead indicate that retraining or finetuning of the natural language processing model is not warranted. Unfortunately, existing techniques facilitate such confidence determination ineffectively.

Indeed, some existing techniques facilitate such confidence determination by detecting model drift; that is, by analyzing the output-side of the natural language processing model. In particular, such existing techniques involve: executing the natural language processing model on the given unstructured text, thereby causing the natural language processing model to produce an inferencing task result (e.g., a classification label, a segmentation mask, a regression output); and evaluating a confidence or certainty of that inferencing task result. Unfortunately, such existing techniques can be considered as consuming excessive computational resources. After all, such existing techniques do not determine confidence until after the natural language processing model has already been executed on the given unstructured text. That is, some time and processing power are spent on executing the natural language processing model so as to generate the inferencing task result, and additional time and processing power are subsequently spent on evaluating a confidence or certainty of the inferencing task result. Thus, if it is determined that the inferencing task result is insufficiently confident or insufficiently certain, the computational time and processing capacity that were expended by the natural language processing model in generating the inferencing task result can be considered as wasted.

Some other existing techniques facilitate such confidence determination by detecting data drift; that is, by analyzing the input-side of the natural language processing model. In particular, such other existing techniques involve comparing the data on which it is desired to execute the natural language processing model to whatever data on which the natural language processing model was trained. If the desired data is sufficiently similar to the training data, it can be concluded that the natural language processing model is able to confidently perform the inferencing task on the desired data as is (e.g., it can be concluded that the natural language processing model can confidently analyze the desired data without first undergoing retraining or fine-tuning). On the other hand, if the desired data is not sufficiently similar to the training data, it can be concluded that the natural language processing model is unable to confidently perform the inferencing task on the desired data as is (e.g., it can be concluded that the natural language processing model needs to first undergo retraining or finetuning in order to confidently analyze the desired data). Such other existing techniques can be considered as not wasting computational resources, since they can be facilitated prior to execution of the natural language processing model. That is, some time and processing power are spent on evaluating whether or not the desired data is sufficiently similar to the training data, and no additional time and processing power are spent on executing the natural language processing model unless the desired data is sufficiently similar to the training data. Unfortunately, however, such other existing techniques are well suited only to scalars, two-dimensional or three-dimensional vectors, categorical data, or short, structured text data. Indeed, such other existing techniques utilize statistical tools to compare desired data to training data, such as Kolmogorov-Smirnov (KS) tests, Kullback-Leibler (KL) divergence tests, or Principal Component Analyses (PCA). Such statistical tools rely upon many underlying assumptions (e.g., linearity of correlation between independent variables, normally distributed features or characteristics) that do not hold true for lengthy spans of unstructured text whose numerical representations are often extremely high-dimensional. Accordingly, such other existing techniques cannot be easily generalized or applied to the given unstructured text on which it is desired to execute the natural language processing model.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate data drift detection for unstructured texts via deep learning autoencoders. In other words, the inventors of various embodiments described herein devised various techniques that utilize deep learning autoencoders to facilitate data drift detection for natural language processing models configured to analyze lengthy, unstructured spans of text. In particular, when given any natural language processing model that is configured to perform an inferencing task on unstructured texts, a respective deep learning autoencoder can be trained on whatever unstructured texts that the natural language processing model was trained on. More specifically, the deep learning autoencoder can be made up of an encoder and a decoder, where the encoder can be trained in unsupervised fashion to convert sentence embeddings of inputted unstructured texts to dimensionally-reduced latent vectors, and where the decoder can be trained in unsupervised fashion to reconstruct sentence embeddings from inputted latent vectors. Because the deep learning autoencoder can be trained on the same unstructured texts that the natural language processing model was trained on, the deep learning autoencoder can be considered as being able to accurately, correctly, or properly condense and reconstruct the sentence embeddings of those training unstructured texts and anything that is similar to those training unstructured texts. So, when given any unstructured text on which it is desired to execute the natural language processing model, the deep learning autoencoder can be executed on that given unstructured text first, and the accuracy or inaccuracy exhibited by the deep learning autoencoder with respect to that given unstructured text can be considered as signaling or indicating whether or not the natural language processing model would be able to accurately or correctly perform the inferencing task on that given unstructured text. In other words, since the deep learning autoencoder and the natural language processing model are both trained on the same data as each other, they can be expected to rise and fall together.

For instance, suppose that the deep learning autoencoder correctly (e.g., with error below any suitable threshold) condenses and reconstructs the sentence embeddings of the given unstructured text. In such case, it can be concluded that the natural language processing model will or would be able to confidently perform the inferencing task on the given unstructured text. Indeed, since the deep learning autoencoder and the natural language processing model are both trained on the same data as each other, they can be expected to accurately analyze the same data as each other.

As another instance, suppose that the deep learning autoencoder instead incorrectly (e.g., with error above any suitable threshold) condenses and reconstructs the sentence embeddings of the given unstructured text. In such case, it can be concluded that the natural language processing model will or would be unable to confidently perform the inferencing task on the given unstructured text. After all, since the deep learning autoencoder and the natural language processing model are both trained on the same data as each other, they can be expected to inaccurately analyze the same data as each other.

In this way, the performance of the deep learning autoencoder can be considered as an advanced or early indication of the likely performance of the natural language processing model: success of the deep learning autoencoder can be considered as signaling likely success of the natural language processing model; whereas failure of the deep learning autoencoder can conversely be considered as signaling likely failure of the natural language processing model. Accordingly, various embodiments described herein can be considered as a clever or inventive utilization of the deep learning autoencoder.

Note that various embodiments described herein can be considered as addressing or ameliorating various disadvantages of existing techniques. Indeed, as mentioned above, some existing techniques estimate confidence of the natural language processing model by detecting model drift. Such existing techniques are performed after execution of the natural language processing model and can thus be considered as wasting computational time or processing capacity (e.g., when such existing techniques are implemented, some time and processing power are spent on executing the natural language processing model, and more time and processing power are spent on evaluating the confidence of the natural language processing model). In stark contrast, various embodiments described herein detect data drift rather than model drift. Such embodiments can be performed before execution of the natural language processing model and can thus avoid wasting computational time and processing capacity (e.g., when various embodiments described herein are implemented, some time and processing power are spent on executing the deep learning autoencoder, but no additional time and processing power are spent on executing the natural language processing model unless the deep learning autoencoder indicates that the natural language processing model can be executed confidently).

Furthermore, as also mentioned above, other existing techniques estimate confidence of the natural language processing model by detecting data drift via statistical tools (e.g., KS tests, KL divergence tests, PCA). Although such other existing techniques can be performed prior to execution of the natural language processing model, such other existing techniques rely on rigid statistical assumptions (e.g., linear correlations, normal distributions) and are thus only applicable to low-dimensional numerical data, categorical data, or short and structured text data. Lengthy, unstructured text data generally does not satisfy the rigid statistical assumptions of such other existing techniques, and so such other existing techniques are not applicable or generalizable to lengthy, unstructured text data. In stark contrast, various embodiments described herein detect data drift not via rigid statistical tests, but instead via execution of the deep learning autoencoder. The deep learning autoencoder can be considered as being unconstrained by the rigid statistical assumptions of such other existing techniques. Accordingly, the deep learning autoencoder can be implemented to analyze lengthy, unstructured text data, unlike such other existing techniques.

Various embodiments described herein can be considered as a computerized tool (e.g., any suitable combination of computer-executable hardware or computer-executable software) that can facilitate data drift detection for unstructured texts via deep learning autoencoders. In various aspects, such computerized tool can comprise an access component, a drift component, or a result component.

In various embodiments, there can be a pre-trained natural language model. In various aspects, the pre-trained natural language model can exhibit any suitable deep learning internal architecture. For example, the pre-trained natural language model can include any suitable numbers of any suitable types of layers (e.g., input layer, one or more hidden layers, output layer, any of which can be convolutional layers, dense layers, non-linearity layers, pooling layers, batch normalization layers, or padding layers). As another example, the pre-trained natural language model can include any suitable numbers of neurons in various layers (e.g., different layers can have the same or different numbers of neurons as each other). As yet another example, the pre-trained natural language model can include any suitable activation functions (e.g., softmax, sigmoid, hyperbolic tangent, rectified linear unit) in various neurons (e.g., different neurons can have the same or different activation functions as each other). As still another example, the pre-trained natural language model can include any suitable interneuron connections or interlayer connections (e.g., forward connections, skip connections, recurrent connections).

Regardless of its internal architecture, the pre-trained natural language model can be configured to perform any suitable inferencing task on any suitable unstructured text report. In various aspects, an unstructured text report can be any suitable electronic document comprising any suitable number of plain text sentences or sentence fragments. In various instances, an unstructured text report can be written, typed, or otherwise implemented in any suitable operational context (e.g., in a clinical or medical operational context). In various cases, the inferencing task can be any suitable predictive computation or functionality that is applicable to unstructured text reports. As some non-limiting examples, the inferencing task can be text classification, text segmentation, or text regression.

In various embodiments, there can be a set of training unstructured text reports. In various aspects, each of the set of training unstructured text reports can be any suitable unstructured text report that the pre-trained natural language model encountered during training. In various instances, the pre-trained natural language model can be or can have been trained on the set of training unstructured text reports via any suitable training paradigm (e.g., supervised training using ground-truth annotations; unsupervised training without ground-truth annotations; reinforcement learning via rewards or punishments).

In various embodiments, there can be a set of inferencing unstructured text reports. In various aspects, each of the set of inferencing unstructured text reports can be any suitable unstructured text report that the pre-trained natural language model did not encounter during training and on which it is desired to perform the inferencing task. That is, the pre-trained natural language model can be desired, slated, or scheduled to be executed on each of the set of inferencing unstructured text reports. However, before such execution is carried out, it can be desired to first determine whether or not the pre-trained natural language model is able to confidently or with certainty analyze the set of inferencing unstructured text reports. As described herein, the computerized tool can facilitate such determination.

In various embodiments, the access component of the computerized tool can electronically receive or otherwise electronically access the set of training unstructured text reports or the set of inferencing unstructured text reports. In some aspects, the access component can electronically retrieve the set of training unstructured text reports or the set of inferencing unstructured text reports from any suitable centralized or decentralized data structures (e.g., graph data structures, relational data structures, hybrid data structures), whether remote from or local to the access component. In any case, the access component can electronically obtain or access the set of training unstructured text reports or the set of inferencing unstructured text reports, such that other components of the computerized tool can electronically interact with (e.g., read, write, edit, copy, manipulate) the set of training unstructured text reports or with the set of inferencing unstructured text reports.

In various embodiments, the drift component of the computerized tool can electronically store, maintain, control, or otherwise access a deep learning autoencoder. In various aspects, the deep learning autoencoder can be trained in unsupervised fashion on the set of training unstructured text reports. In various instances, the drift component can utilize or leverage the deep learning autoencoder, so as to determine whether or not the set of inferencing unstructured text reports are insufficiently similar to (e.g., have drifted too far from) the set of training unstructured text reports.

More specifically, the drift component can, in various aspects, electronically convert the set of training unstructured text reports into a first set of sentence embedding collections. That is, for each given training unstructured text report, the drift component can create a respective collection of sentence embeddings, where each sentence embedding in that respective collection can be a numerical representation of a corresponding sentence in that given training unstructured text report. In various instances, the drift component can generate the first set of sentence embedding collections via any suitable sentence embedding or encoding techniques (e.g., Universal Sentence Encoder (USE), Bidirectional Encoder Representations from Transformers (BERT)).

Likewise, in various cases, the drift component can electronically convert the set of inferencing unstructured text reports into a second set of sentence embedding collections. That is, for each given inferencing unstructured text report, the drift component can create a respective collection of sentence embeddings, where each sentence embedding in that respective collection can be a numerical representation of a corresponding sentence in that given inferencing unstructured text report. Just as above, the drift component can generate the second set of sentence embedding collections via any suitable sentence embedding or encoding techniques.

Now, in various instances, the deep learning autoencoder can comprise an encoder portion and a decoder portion, where the decoder portion can be serially downstream of the encoder portion.

In various aspects, the encoder portion can exhibit any suitable deep learning internal architecture. For example, the encoder portion can include any suitable numbers of any suitable types of layers (e.g., input layer, one or more hidden layers, output layer, any of which can be convolutional layers, dense layers, non-linearity layers, pooling layers, batch normalization layers, long short-term memory (LSTM) layers, or padding layers). As another example, the encoder portion can include any suitable numbers of neurons in various layers (e.g., different layers can have the same or different numbers of neurons as each other). As yet another example, the encoder portion can include any suitable activation functions (e.g., softmax, sigmoid, hyperbolic tangent, rectified linear unit) in various neurons (e.g., different neurons can have the same or different activation functions as each other). As still another example, the encoder portion can include any suitable interneuron connections or interlayer connections (e.g., forward connections, skip connections, recurrent connections).

Likewise, in various aspects, the decoder portion can exhibit any suitable deep learning internal architecture. For example, the decoder portion can include any suitable numbers of any suitable types of layers (e.g., input layer, one or more hidden layers, output layer, any of which can be convolutional layers, dense layers, non-linearity layers, pooling layers, batch normalization layers, LSTM layers, or padding layers). As another example, the decoder portion can include any suitable numbers of neurons in various layers (e.g., different layers can have the same or different numbers of neurons as each other). As yet another example, the decoder portion can include any suitable activation functions (e.g., softmax, sigmoid, hyperbolic tangent, rectified linear unit) in various neurons (e.g., different neurons can have the same or different activation functions as each other). As still another example, the decoder portion can include any suitable interneuron connections or interlayer connections (e.g., forward connections, skip connections, recurrent connections).

Regardless of their particular internal architectures, the encoder can be configured to compress an inputted sentence embedding collection into a condensed latent vector (e.g., into a dimensionally-reduced numerical representation of those sentence embeddings), whereas the decoder portion can instead be configured to reconstruct a sentence embedding collection from an inputted condensed latent vector. In other words, the deep learning autoencoder can be considered as exhibiting an uncompressed-to-compressed-to-uncompressed bottleneck architecture.

More specifically, the drift component can select any given sentence embedding collection from the first set of sentence embedding collections or from the second set of sentence embedding collections. In various aspects, the drift component can execute the deep learning autoencoder on the selected sentence embedding collection, and such execution can cause the deep learning autoencoder to produce a reconstructed sentence embedding collection.

In particular, the selected sentence embedding collection can comprise any suitable number of sentence embeddings. In various instances, the drift component can feed (e.g., in concatenated fashion; or in recurrent or sequential fashion) those sentence embeddings to an input layer of the encoder portion. In various cases, those sentence embeddings can complete a forward pass through one or more hidden layers of the encoder portion. In various aspects, an output layer of the encoder portion can calculate a condense latent vector, based on activation maps provided by the one or more hidden layers of the encoder portion. In various instances, the condensed latent vector can be considered as a dimensionally-reduced numerical representation of the selected sentence embedding collection. In other words, the condensed latent vector can comprise fewer (e.g., in some cases, many orders of magnitude fewer) numerical elements than the selected sentence embedding collection but can nevertheless capture (e.g., albeit in hidden or obscure fashion) at least some substantive content of the selected sentence embedding collection.

In various cases, the condensed latent vector can be fed to an input layer of the decoder portion. In various aspects, the condensed latent vector can complete a forward pass through one or more hidden layers of the decoder portion. In various aspects, an output layer of the decoder portion can calculate the reconstructed sentence embedding collection, based on activation maps provided by the one or more hidden layers of the decoder portion. In various instances, the reconstructed sentence embedding collection can have the same format, size, or dimensionality as (e.g., can comprise the same total number of numerical elements as) the selected sentence embedding collection. Accordingly, the reconstructed sentence embedding collection can be considered as being whatever sentence embeddings that the decoder portion has predicted or inferred are captured or represented by the condensed latent vector.

In various instances, the drift component can compute an error between the selected sentence embedding collection and the reconstructed sentence embedding collection, and such error can be referred to as a reconstruction error. In various aspects, the drift component can utilize any suitable objective or loss function to compute the reconstruction error (e.g., Euclidean distance difference, complement or reciprocal of cosine similarity, mean absolute error (MAE), mean squared error (MSE), cross-entropy error). In any case, the reconstruction error can be a scalar whose magnitude indicates how different or how similar the reconstructed sentence embedding collection is to the selected sentence embedding collection (e.g., a higher reconstruction error can indicate a larger difference or less similarity).

In various aspects, the drift component can compute a respective reconstruction error in this way for each of the first set of sentence embedding collections, thereby yielding a first set of reconstruction errors. Likewise, the drift component can compute a respective reconstruction error in this way for each of the second set of sentence embedding collections, thereby yielding a second set of reconstruction errors. In various instances, the drift component can determine whether or not the set of inferencing unstructured text reports is insufficiently similar to (e.g., has drifted too far from) the set of training unstructured text reports, by comparing the first set of reconstruction errors to the second set of reconstruction errors. As a non-limiting example, the drift component can compute a first aggregated reconstruction error (e.g., average reconstruction error, mean square reconstruction error, root mean square reconstruction error) based on the first set of reconstruction errors, and the drift component can likewise compute a second aggregated reconstruction error based on the second set of reconstruction errors.

If the first aggregated reconstruction error is within any suitable threshold margin of the second aggregated reconstruction error, the drift component can determine that the set of inferencing unstructured text reports is sufficiently similar to, and thus has not drifted too far from, the set of training unstructured text reports. In such case, the drift component can conclude that the pre-trained natural language model will or would be able to confidently or with certainty perform the inferencing task on the set of inferencing unstructured text reports. In other words, the drift component can conclude that the pre-trained natural language model need not first undergo retraining or fine-tuning before being executed on the set of inferencing unstructured text reports.

Instead, if the first aggregated reconstruction error differs by more than any suitable threshold margin from the second aggregated reconstruction error, the drift component can determine that the set of inferencing unstructured text reports is insufficiently similar to, and thus has drifted too far from, the set of training unstructured text reports. In such case, the drift component can conclude that the pre-trained natural language model will not or would not be able to confidently or with certainty perform the inferencing task on the set of inferencing unstructured text reports. In other words, the drift component can conclude that the pre-trained natural language model should first undergo retraining or fine-tuning before being executed on the set of inferencing unstructured text reports.

In various embodiments, the result component of the computerized tool can electronically generate a drift alert, based on the determinations or conclusions of the drift component. If the drift component concludes that the pre-trained natural language model will or would be able to confidently or with certainty perform the inferencing task on the set of inferencing unstructured text reports, the drift alert can be any suitable electronic notification indicating such and recommending that the pre-trained natural language model be executed on the set of inferencing unstructured text reports. Instead, if the drift component concludes that the pre-trained natural language model will not or would not be able to confidently or with certainty perform the inferencing task on the set of inferencing unstructured text reports, the drift alert can be any suitable electronic notification indicating such and recommending that the pre-trained natural language model not be executed on the set of inferencing unstructured text reports without first being retrained or fine-tuned. In any case, the result component can electronically render the drift alert on any suitable electronic display, or the result component can electronically transmit the drift alert to any suitable computing device. In some aspects, if the drift component concludes that the pre-trained natural language model will not or would not be able to confidently or with certainty perform the inferencing task on the set of inferencing unstructured text reports, the result component can electronically prevent, prohibit, or otherwise forbid the pre-trained natural language model from being executed on the set of inferencing unstructured text reports.

In this way, the computerized tool can leverage the deep learning autoencoder to detect data drift between the set of inferencing unstructured text reports and the set of training unstructured text reports.

Various embodiments described herein can be employed to use hardware or software to solve problems that are highly technical in nature (e.g., to facilitate data drift detection for unstructured text via deep learning autoencoders), that are not abstract and that cannot be performed as a set of mental acts by a human. Further, some of the processes performed can be performed by a specialized computer (e.g., a deep learning autoencoder having internal parameters such as convolutional kernels or long short-term memory layers) for carrying out defined acts related to natural language processing.

For example, such defined acts can include: accessing, by a device operatively coupled to a processor, a pre-trained natural language model and a set of unstructured text reports on which the pre-trained natural language model is to be executed; determining, by the device and via execution of a deep learning autoencoder, how different a first set of reconstruction errors associated with the set of unstructured text reports are from a second set of reconstruction errors associated with a set of training unstructured text reports on which the pre-trained natural language model was trained; and generating, by the device and in response to a determination that the first set of reconstruction errors differ from the second set of reconstruction errors by more than a threshold margin, a first alert indicating that data drift has occurred and that the pre-trained natural language model is thereby unable to confidently analyze the set of unstructured text reports.

Such defined acts are not performed manually by humans. Indeed, neither the human mind nor a human with pen and paper can: electronically train a deep learning autoencoder on the same electronic plain text documents that were used to train a natural language processing model; and electronically determine whether or not the natural language processing model is able to confidently analyze one or more new electronic plain text documents by executing the deep learning autoencoder on those one or more new electronic plain text documents. Indeed, deep learning neural networks (e.g., a natural language processing model, a deep learning autoencoder) are inherently-computerized constructs that simply cannot be meaningfully executed or trained in any way by the human mind without computers. Furthermore, data drift detection is an inherently-computerized computational task that cannot be meaningfully implemented in any way by the human mind without computers. Accordingly, a computerized tool that can detect, via execution of a deep learning autoencoder, data drift for a natural language processing model configured to analyze lengthy, plain text electronic documents is likewise inherently-computerized and cannot be implemented in any sensible, practical, or reasonable way without computers.

Moreover, various embodiments described herein can integrate into a practical application various teachings relating to data drift detection for unstructured text via deep learning autoencoders. As explained above, when given a natural language processing model that has been trained to perform an inferencing task on unstructured texts, it can be desired to determine how confidently the natural language processing model is able to perform the inferencing task with respect to any particular unstructured text. Some existing techniques facilitate this confidence determination via model drift detection. Unfortunately, such existing techniques are performed only after the natural language processing model has already been executed on the particular unstructured text, which can be considered as wasteful (e.g., if such existing techniques determine that the natural language processing model unconfidently performed the inferencing task on the particular unstructured text, then whatever time and processing capacity were spent on executing the natural language processing model on the particular unstructured text can be considered as having been wasted). Other existing techniques facilitate this confidence determination via data drift detection. Such other existing techniques can be performed prior to execution of the natural language processing model on the particular unstructured text, thereby saving time and processing capacity. Unfortunately, however, such other existing techniques utilize statistical tests (e.g., KS tests, KL divergence tests, PCA) that rely upon rigid assumptions (e.g., linearity of independent variables) that are generally satisfied only by well-behaved, low-dimensional data (e.g., scalars, two-dimensional or three-dimensional vectors, categorical data, short and structured text) and that are generally not satisfied by lengthy, plain text documents having high-dimensional numerical representations (e.g., hundreds or thousands of dimensions). Accordingly, such other existing techniques cannot easily or accurately be applied to the particular unstructured text. For at least these reasons, existing techniques can be considered as disadvantageous.

In stark contrast, various embodiments described herein can address one or more of these technical problems. Specifically, various embodiments described herein can involve detecting data drift via implementation of a deep learning autoencoder that is trained in unsupervised fashion on the same unstructured texts that the natural language processing model was trained on. In particular, such training can be considered as teaching the deep learning autoencoder to compress and subsequently reconstruct sentence embeddings corresponding to the unstructured texts that the natural language processing model was trained on. Prior to executing the natural language processing model on the particular unstructured text, the deep learning autoencoder can be executed on the particular unstructured text, and how well or how poorly the deep learning autoencoder is able to compress and subsequently reconstruct the sentence embeddings of the particular unstructured text can signal or indicate whether or not the natural language processing model will be able to confidently analyze the particular unstructured text. In other words, because the deep learning autoencoder and the natural language processing model can be trained on the same unstructured texts as each other, they can be considered as rising or falling together. Thus, if the deep learning autoencoder is able to correctly (e.g., with less than any suitable threshold margin of error) compress and reconstruct the sentence embeddings of the particular unstructured text, then it can be expected that the natural language processing model will likewise be able to correctly or confidently analyze the particular unstructured text. In such case, the particular unstructured text can be considered as not having drifted too far from the unstructured texts on which the natural language processing model (and the deep learning autoencoder) was trained, meaning that retraining or fine-tuning of the natural language processing model can be unwarranted. On the other hand, if the deep learning autoencoder is unable to correctly compress and reconstruct the sentence embeddings of the particular unstructured text, then it can be expected that the natural language processing model will likewise be unable to correctly or confidently analyze the particular unstructured text. In such case, the particular unstructured text can be considered as having drifted too far from the unstructured texts on which the natural language processing model (and the deep learning autoencoder) was trained, meaning that retraining or fine-tuning of the natural language processing model can be warranted. Various embodiments described herein can perform data drift detection (rather than model drift detection) and have a technical advantage of being implemented prior to execution of the natural language processing model on the particular unstructured text, thereby avoiding or reducing waste of computational resources as compared to existing techniques that perform model drift detection. Furthermore, various embodiments described herein can utilize a deep learning autoencoder which can be considered as well-suited to analyzing lengthy, plain text electronic documents whose numerical representations are often very high-dimensional (e.g., involving hundreds or thousands of numerical dimensions), unlike existing techniques that rely upon rigid statistical tests. Thus, various embodiments described herein can be considered as outperforming existing techniques.

For at least these reasons, various embodiments described herein certainly constitute concrete and tangible technical improvements or technical advantages in the field of natural language processing, and such embodiments therefore clearly qualify as useful and practical applications of computers.

Furthermore, various embodiments described herein can control real-world tangible devices based on the disclosed teachings. For example, various embodiments described herein can electronically execute or train real-world deep learning autoencoders and can electronically render, on computer screens, real-world alerts or notifications based on such real-world deep learning autoencoders.

It should be appreciated that the herein figures and description provide non-limiting examples of various embodiments and are not necessarily drawn to scale.

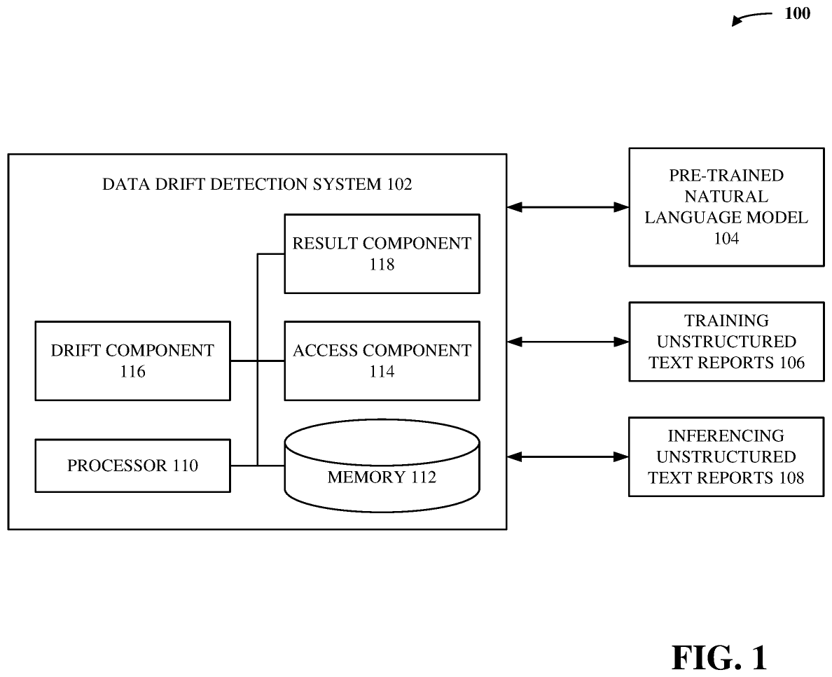

FIG. 1 illustrates a block diagram of an example, non-limiting system 100 that can facilitate data drift detection for unstructured texts via deep learning autoencoders in accordance with one or more embodiments described herein. As shown, a data drift detection system 102 can be electronically integrated, via any suitable wired or wireless electronic connections, with a pre-trained natural language model 104, with a set of training unstructured text reports 106, or with a set of inferencing unstructured text reports 108.

In various embodiments, the pre-trained natural language model 104 can be any suitable artificial neural network that can have or otherwise exhibit any suitable internal architecture. For instance, the pre-trained natural language model 104 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As even another example, any of such input layer, one or more hidden layers, or output layer can be long short-term memory (LSTM) layers, whose learnable or trainable parameters can be input-state weight matrices or hidden-state weight matrices. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of its particular internal architecture, the pre-trained natural language model 104 can be configured to perform an inferencing task on an unstructured text report.

In various aspects, an unstructured text report can be any suitable electronic document that comprises any suitable number of plain text sentences or plain text sentence fragments which can comprise any suitable number of words written in any suitable language (e.g., English, French, Spanish). In some instances, an unstructured text report can be short in length (e.g., can take up less than a single electronic page). In other instances, an unstructured text report can be long in length (e.g., can take up multiple electronic pages). In various cases, an unstructured text report can be implemented in any suitable operational context. Indeed, in some aspects, an unstructured text report can be implemented in a clinical or medical context. In such case, the substantive or semantic content of the unstructured text report can relate diagnostically or prognostically to a medical patient (e.g., human, animal, or otherwise). As a non-limiting example, the unstructured text report can be written or typed by any suitable medical professional (e.g., nurse, physician) as part of an electronic medical record or electronic medical chart of the medical patient, using any suitable human-computer interface device (e.g., keyboard, touchscreen, voice dictation system). Accordingly, the unstructured text report can describe or explain medical symptoms experienced or not experienced by the medical patient, surgical procedures undergone or not undergone by the medical patient, or medical treatments recommended or not recommended for the medical patient. However, this is a mere non-limiting example. In other aspects, an unstructured text report can pertain to any other suitable, non-medical operational context (e.g., can pertain to an automotive context, in which case the unstructured text report can describe or explain automotive information about an automotive client; can pertain to a legal context, in which case the unstructured text report can describe or explain legal information about a legal client; or can pertain to a financial context, in which case the unstructured text report can describe or explain financial information about a financial client).

In various instances, the inferencing task can be any suitable predictive computation that can be performed on or that is otherwise relevant to natural language texts. As a non-limiting example, the inferencing task can be text classification. As another non-limiting example, the inferencing task can be text segmentation. As even another non-limiting example, the inferencing task can be text regression.

In various embodiments, the pre-trained natural language model 104 can be or can have been trained on the set of training unstructured text reports 106 to perform the inferencing task. In various aspects, the set of training unstructured text reports 106 can comprise any suitable number of training unstructured text reports. In various instances, a training unstructured text report can be any suitable unstructured text report (e.g., any suitable electronic plain text document or natural language document) that the pre-trained natural language model 104 encountered during training. In various cases, the pre-trained natural language model 104 can be or can have been trained on the set of training unstructured text reports 106 using any suitable training paradigm.

As a non-limiting example, the pre-trained natural language model 104 can have undergone supervised training with respect to the set of training unstructured text reports 106. In such case, each of the set of training unstructured text reports 106 can correspond to a respective ground-truth annotation (e.g., a respective ground-truth classification label, a respective ground-truth segmentation mask, a respective ground-truth regression result). In particular, the pre-trained natural language model 104 can be or can have been executed on each of the set of training unstructured text reports 106, and the trainable internal parameters (e.g., convolutional kernels, weight matrices, bias vectors) of the pre-trained natural language model 104 can be or can have been incrementally updated via backpropagation based on errors (e.g., mean absolute errors (MAE), mean squared errors (MSE), cross-entropy errors) between inferencing task results predicted by the pre-trained natural language model 104 and such ground-truth annotations.

As another non-limiting example, the pre-trained natural language model 104 can have undergone unsupervised training with respect to the set of training unstructured text reports 106. In such case, none of the set of training unstructured text reports 106 can correspond to a respective ground-truth annotation. In particular, the pre-trained natural language model 104 can be or can have been executed on each of the set of training unstructured text reports 106, and the trainable internal parameters of the pre-trained natural language model 104 can be or can have been incrementally updated via backpropagation based on errors derived from the set of training unstructured text reports 106.

As still another non-limiting example, the pre-trained natural language model 104 can have undergone reinforcement learning with respect to the set of training unstructured text reports 106. In such case, the pre-trained natural language model 104 can be or can have been executed on each of the set of training unstructured text reports 106, and the trainable internal parameters of the pre-trained natural language model 104 can be or can have been incrementally updated via backpropagation based on a reward or punishment policy.

In various embodiments, the pre-trained natural language model 104 can be scheduled, slated, planned, desired, or otherwise intended to be executed on each of the set of inferencing unstructured text reports 108. In various aspects, the set of inferencing unstructured text reports 108 can comprise any suitable number of inferencing unstructured text reports. In various instances, a inferencing unstructured text report can be any suitable unstructured text report (e.g., any suitable electronic plain text document or natural language document) that the pre-trained natural language model 104 did not encounter during training but on which performance of the inferencing task is nevertheless desired.

In various cases, prior to executing the pre-trained natural language model 104 on the set of inferencing unstructured text reports 108, it can be desired to first determine whether or not the pre-trained natural language model 104 can confidently or reliably perform the inferencing task on the set of inferencing unstructured text reports 108. In various aspects, the pre-trained natural language model 104 can be considered as being able to confidently or reliably perform the inferencing task only on unstructured text reports that are not too dissimilar to or that have not drifted too far from those on which the pre-trained natural language model 104 was trained. Accordingly, it can be desired to determine whether or not the set of inferencing unstructured text reports 108 are sufficiently similar to the set of training unstructured text reports 106. As described herein, the data drift detection system 102 can facilitate such determination.

In various embodiments, the data drift detection system 102 can comprise a processor 110 (e.g., computer processing unit, microprocessor) and a non-transitory computer-readable memory 112 that is operably or operatively or communicatively connected or coupled to the processor 110. The non-transitory computer-readable memory 112 can store computer-executable instructions which, upon execution by the processor 110, can cause the processor 110 or other components of the data drift detection system 102 (e.g., access component 114, drift component 116, result component 118) to perform one or more acts. In various embodiments, the non-transitory computer-readable memory 112 can store computer-executable components (e.g., access component 114, drift component 116, result component 118), and the processor 110 can execute the computer-executable components.

In various embodiments, the data drift detection system 102 can comprise an access component 114. In various aspects, the access component 114 can electronically receive or otherwise electronically access the set of training unstructured text reports 106 or the set of inferencing unstructured text reports 108. In various instances, the access component 114 can electronically retrieve the set of training unstructured text reports 106 or the set of inferencing unstructured text reports 108 from any suitable centralized or decentralized data structures (not shown) or from any suitable centralized or decentralized computing devices (not shown). As a non-limiting example, the access component 114 can electronically retrieve the set of training unstructured text reports 106 or the set of inferencing unstructured text reports 108 from whatever interface-equipped computing device into which or onto which the set of training unstructured text reports 106 or the set of inferencing unstructured text reports 108 were typed (e.g., desktop computer, laptop computer, smart phone, tablet). In any case, the access component 114 can electronically obtain or access the set of training unstructured text reports 106 or the set of inferencing unstructured text reports 108, such that other components of the data drift detection system 102 can electronically interact (e.g., by proxy) with the set of training unstructured text reports 106 or with the set of inferencing unstructured text reports 108.

In various embodiments, the data drift detection system 102 can comprise a drift component 116. In various aspects, the drift component 116 can, as described herein, leverage a deep learning autoencoder to determine whether or not the set of inferencing unstructured text reports 108 has drifted too far from (e.g., is too dissimilar to) the set of training unstructured text reports 106.

In various embodiments, the data drift detection system 102 can comprise a result component 118. In various aspects, the result component 118 can, as described herein, render or transmit a drift alert, based on the determination generated by the drift component 116.

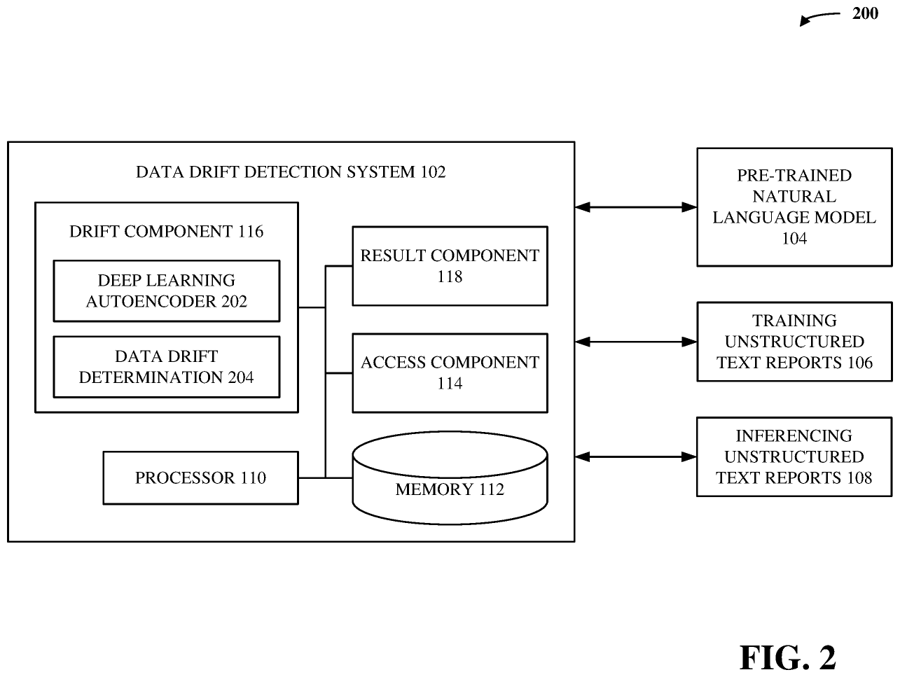

FIG. 2 illustrates a block diagram of an example, non-limiting system 200 including a deep learning autoencoder and a data drift determination that can facilitate data drift detection for unstructured texts via deep learning autoencoders in accordance with one or more embodiments described herein. As shown, the system 200 can, in some cases, comprise the same components as the system 100, and can further comprise a deep learning autoencoder 202 and a data drift determination 204.

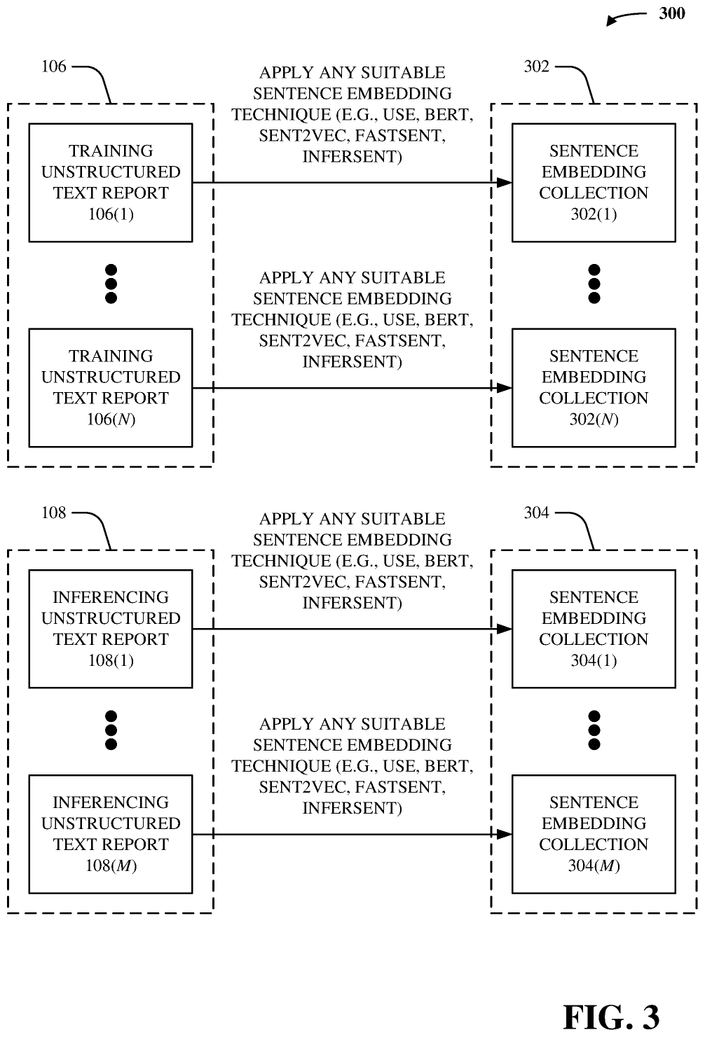

In various embodiments, the drift component 116 can electronically store, electronically maintain, electronically control, or otherwise electronically access the deep learning autoencoder 202. In various aspects, the deep learning autoencoder 202 can, as described herein, be trained on the set of training unstructured text reports 106. In various instances, the drift component 116 can leverage or utilize the deep learning autoencoder 202, so as to generate the data drift determination 204. In various cases, the data drift determination 204 can be any suitable electronic data that indicates or otherwise specifies whether or not the set of inferencing unstructured text reports 108 has drifted too far from (e.g., is too dissimilar to) the set of training unstructured text reports 106. Various non-limiting aspects are described with respect to FIGS. 3-5.

FIGS. 3-5 illustrate example, non-limiting block diagrams 300, 400, and 500 showing how the deep learning autoencoder 202 can be leveraged to make the data drift determination 204 in accordance with one or more embodiments described herein.

First, consider FIG. 3. In various embodiments, as shown, the set of training unstructured text reports 106 can comprise n reports for any suitable positive integer n: a training unstructured text report 106(1) to a training unstructured text report 106(n). In various aspects, the drift component 116 can electronically generate a respective collection of sentence embeddings for each of the set of training unstructured text reports 106.

As a non-limiting example, the drift component 116 can electronically generate a sentence embedding collection 302(1) for the training unstructured text report 106(1). More specifically, the training unstructured text report 106(1) can comprise any suitable number of sentences, the drift component 116 can electronically generate a respective sentence embedding for each of those sentences, and such sentence embeddings can collectively be considered or otherwise referred to as the sentence embedding collection 302(1). For instance, if the training unstructured text report 106(1) comprises x1 sentences for any suitable positive integer x1, then the sentence embedding collection 302(1) can likewise comprise x1 sentence embeddings. In various instances, a sentence embedding can be one or more scalars, one or more vectors, one or more matrices, one or more tensors, or any suitable combination thereof that can be considered as numerically representing the semantic or substantive content of a respective or corresponding sentence. In various cases, the drift component 116 can electronically generate the sentence embedding collection 302(1) by applying any suitable sentence embedding techniques to the training unstructured text report 106(1). For instance, the drift component 116 can generate the sentence embedding collection 302(1) by applying any suitable Universal Sentence Encoder (USE) technique to the training unstructured text report 106(1). In another instance, the drift component 116 can generate the sentence embedding collection 302(1) by applying any suitable Bidirectional Encoder Representations from Transformers (BERT) technique to the training unstructured text report 106(1). In yet another instance, the drift component 116 can generate the sentence embedding collection 302(1) by applying any suitable Sent2Vec technique to the training unstructured text report 106(1). In still another instance, the drift component 116 can generate the sentence embedding collection 302(1) by applying any suitable FastSent technique to the training unstructured text report 106(1). In even another instance, the drift component 116 can generate the sentence embedding collection 302(1) by applying any suitable InferSent technique to the training unstructured text report 106(1). In another instance, the drift component 116 can generate the sentence embedding collection 302(1) by applying any suitable Skip-Thought Vector technique to the training unstructured text report 106(1). Although any of these sentence embedding techniques can be utilized, the present inventors found that USE techniques provided improved performance (e.g., USE does not ignore word-order in sentences, USE helps to reduce amount of information lost during embedding).

As another non-limiting example, the drift component 116 can electronically generate a sentence embedding collection 302(n) for the training unstructured text report 106(n). In particular, the training unstructured text report 106(n) can comprise any suitable number of sentences, the drift component 116 can electronically generate a respective sentence embedding for each of those sentences, and such sentence embeddings can collectively be considered or otherwise referred to as the sentence embedding collection 302(n). For instance, if the training unstructured text report 106(n) comprises xn sentences for any suitable positive integer xn, then the sentence embedding collection 302(n) can likewise comprise xn sentence embeddings. Just as above, the drift component 116 can electronically generate the sentence embedding collection 302(n) by applying any suitable sentence embedding techniques (e.g., USE, BERT, Sent2Vec, FastSent, InferSent, Skip-Thought Vectors) to the training unstructured text report 106(n).

In various cases, the sentence embedding collection 302(1) to the sentence embedding collection 302(n) can be collectively referred to as a set of sentence embedding collections 302. Furthermore, since each of the set of training unstructured text reports 106 can have the same or different numbers of sentences as each other, each of the set of sentence embedding collections 302 can likewise have the same or different numbers of sentence embeddings as each other.

In various aspects, as shown, the set of inferencing unstructured text reports 108 can comprise m reports for any suitable positive integer m: a inferencing unstructured text report 108(1) to a inferencing unstructured text report 108(m). In various aspects, the drift component 116 can electronically generate a respective collection of sentence embeddings for each of the set of inferencing unstructured text reports 108.

As a non-limiting example, the drift component 116 can electronically generate a sentence embedding collection 304(1) for the inferencing unstructured text report 108(1). In particular, the inferencing unstructured text report 108(1) can comprise any suitable number of sentences, the drift component 116 can electronically generate a respective sentence embedding for each of those sentences, and such sentence embeddings can collectively be considered or otherwise referred to as the sentence embedding collection 304(1). For instance, if the inferencing unstructured text report 108(1) comprises y₁ sentences for any suitable positive integer y₁, then the sentence embedding collection 304(1) can likewise comprise y₁ sentence embeddings. Just as above, the drift component 116 can electronically generate the sentence embedding collection 304(1) by applying any suitable sentence embedding techniques (e.g., USE, BERT, Sent2Vec, FastSent, InferSent, Skip-Thought Vectors) to the inferencing unstructured text report 108(1).

As another non-limiting example, the drift component 116 can electronically generate a sentence embedding collection 304(m) for the inferencing unstructured text report 108(m). In particular, the inferencing unstructured text report 108(m) can comprise any suitable number of sentences, the drift component 116 can electronically generate a respective sentence embedding for each of those sentences, and such sentence embeddings can collectively be considered or otherwise referred to as the sentence embedding collection 304(m). For instance, if the inferencing unstructured text report 108(m) comprises yₘ sentences for any suitable positive integer yₘ, then the sentence embedding collection 304(m) can likewise comprise yₘ sentence embeddings. Just as above, the drift component 116 can electronically generate the sentence embedding collection 304(m) by applying any suitable sentence embedding techniques (e.g., USE, BERT, Sent2Vec, FastSent, InferSent, Skip-Thought Vectors) to the inferencing unstructured text report 108(m).

In various cases, the sentence embedding collection 304(1) to the sentence embedding collection 304(m) can be collectively referred to as a set of sentence embedding collections 304. Furthermore, since each of the set of inferencing unstructured text reports 108 can have the same or different numbers of sentences as each other, each of the set of sentence embedding collections 304 can likewise have the same or different numbers of sentence embeddings as each other.

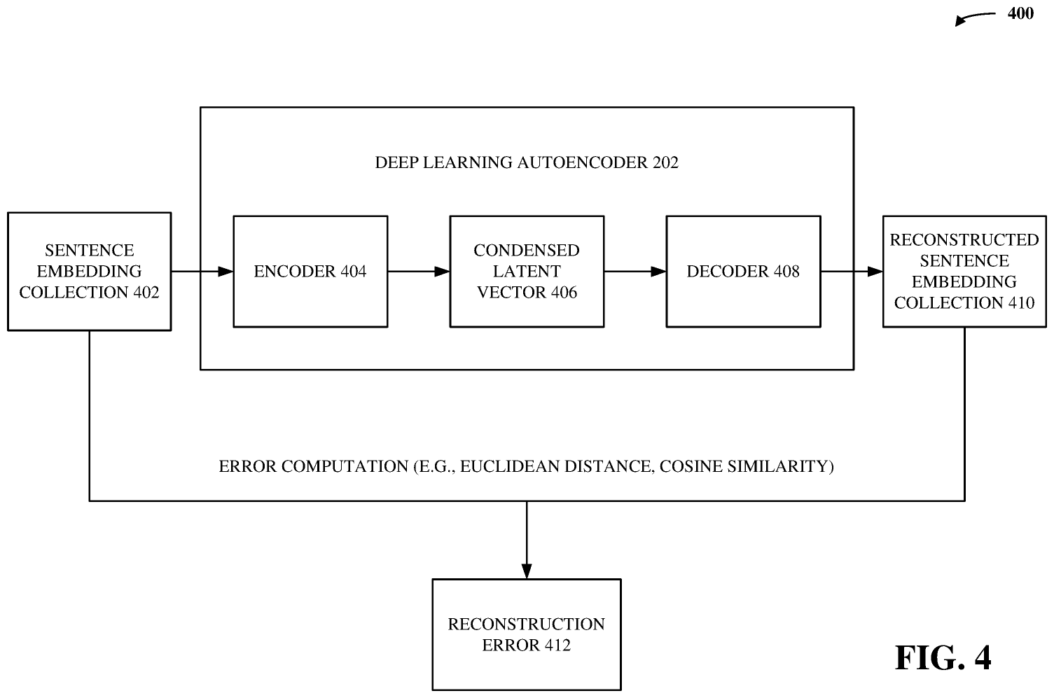

Now, consider FIG. 4. In various embodiments, as shown, the deep learning autoencoder 202 can comprise an encoder 404 and a decoder 408, where the decoder 408 can be located immediately downstream of the encoder 404.

In various aspects, the encoder 404 can be any suitable artificial neural network that can have or otherwise exhibit any suitable internal architecture. For instance, the encoder 404 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As even another example, any of such input layer, one or more hidden layers, or output layer can be LSTM layers, whose learnable or trainable parameters can be input-state weight matrices or hidden-state weight matrices. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Likewise, in various cases, the decoder 408 can be any suitable artificial neural network that can have or otherwise exhibit any suitable internal architecture. For instance, the decoder 408 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As even another example, any of such input layer, one or more hidden layers, or output layer can be LSTM layers, whose learnable or trainable parameters can be input-state weight matrices or hidden-state weight matrices. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In any case, the encoder 404 can be configured to generate condensed latent vectors based on inputted sentence embedding collections, and the decoder 408 can instead be configured to reconstruct sentence embedding collections from inputted condensed latent vectors. Accordingly, the deep learning autoencoder 202 can be considered as having a bottleneck architecture that condenses and subsequently reconstructs any inputted sentence embedding collection.

As a non-limiting example, consider a sentence embedding collection 402. In various aspects, the sentence embedding collection 402 can be any of the set of sentence embedding collections 302 or any of the set of sentence embedding collections 304. In various instances, the drift component 116 can electronically execute the deep learning autoencoder 202 on the sentence embedding collection 402, and such execution can cause the deep learning autoencoder 202 to generate a reconstructed sentence embedding collection 410.

More specifically, suppose that the sentence embedding collection 402 comprises z sentence embeddings, for any suitable positive integer z. In various cases, the drift component 116 can feed (e.g., in concatenated fashion; or in recurrent or sequential fashion) those z sentence embeddings to an input layer of the encoder 404. In various aspects, those z sentence embeddings can complete a forward pass through one or more hidden layers of the encoder 404. In various instances, an output layer of the encoder 404 can compute a condensed latent vector 406, based on activation maps or feature maps produced by the one or more hidden layers of the encoder 404.

In various cases, the condensed latent vector 406 can be one or more scalars, one or more vectors, one or more matrices, one or more tensors, or any suitable combination thereof that can have a smaller dimensionality than the sentence embedding collection 402 but that can nevertheless capture or represent substantive content of the sentence embedding collection 402. For instance, suppose that each of the z sentence embeddings in the sentence embedding collection 402 is a q-element vector, for any suitable positive integer q. In some cases, the sentence embedding collection 402 can thus be considered as having a total dimensionality of z*q (e.g., as having a total cardinality of z*q numerical elements). In such case, the condensed latent vector 406 can have a total dimensionality or cardinality that is less than z*q, hence the term “condensed.” Indeed, in some aspects, the total dimensionality or cardinality of the condensed latent vector 406 can be one or more orders of magnitude less than z*q. In any case, despite such reduced dimensionality or cardinality, the condensed latent vector 406 can nevertheless represent, convey, or otherwise capture (e.g., albeit in an obscure, hidden, or not readily-apparent fashion) at least some of whatever substantive content is contained within the sentence embedding collection 402.

Now, in various aspects, the condensed latent vector 406 can be fed to an input layer of the decoder 408. In various instances, the condensed latent vector 406 can complete a forward pass through one or more hidden layers of the decoder 408. In various cases, an output layer of the decoder 408 can compute (e.g., in concatenated fashion; or in recurrent or sequential fashion) the reconstructed sentence embedding collection 410, based on activation maps or feature maps produced by the one or more hidden layers of the decoder 408.

In various aspects, the reconstructed sentence embedding collection 410 can have the same format, size, or dimensionality as the sentence embedding collection 402. Accordingly, since the sentence embedding collection 402 can comprise z sentence embeddings, each of which can be a q-element vector, the reconstructed sentence embedding collection 410 can likewise comprise z reconstructed sentence embeddings, each of which can be a q-element vector. In various instances, the reconstructed sentence embedding collection 410 can be considered as being whatever sentence embeddings that the decoder 408 infers or predicts are captured or represented by the condensed latent vector 406.

Now, in various embodiments, the drift component 116 can electronically compute a reconstruction error 412 between the sentence embedding collection 402 and the reconstructed sentence embedding collection 410. In various aspects, the reconstruction error 412 can be equal to or otherwise based on any suitable error function. As a non-limiting example, the reconstruction error 412 can be equal to or otherwise based on a Euclidean distance between the sentence embedding collection 402 and the reconstructed sentence embedding collection 410. As another non-limiting example, the reconstruction error 412 can be based on a cosine similarity between the sentence embedding collection 402 and the reconstructed sentence embedding collection 410. As even another non-limiting example, the reconstruction error 412 can be equal to or otherwise based on an MAE between the sentence embedding collection 402 and the reconstructed sentence embedding collection 410. As yet another non-limiting example, the reconstruction error 412 can be equal to or otherwise based on an MSE between the sentence embedding collection 402 and the reconstructed sentence embedding collection 410. As still another non-limiting example, the reconstruction error 412 can be equal to or otherwise based on a cross-entropy error between the sentence embedding collection 402 and the reconstructed sentence embedding collection 410.

In any case, the reconstruction error 412 can be considered as a scalar indicating how different the reconstructed sentence embedding collection 410 is from the sentence embedding collection 402. The lower the magnitude of the reconstruction error 412, the more similar the reconstructed sentence embedding collection 410 and the sentence embedding collection 402 can be considered. In contrast, the higher the magnitude of the reconstruction error 412, the less similar the reconstructed sentence embedding collection 410 and the sentence embedding collection 402 can be considered. In other words, lower values of the reconstruction error 412 can be considered as indicating that the deep learning autoencoder 202 correctly or accurately condensed and subsequently reconstructed the sentence embedding collection 402, whereas larger values of the reconstruction error 412 can instead be considered as indicating that the deep learning autoencoder 202 incorrectly or inaccurately condensed and subsequently reconstructed the sentence embedding collection 402.

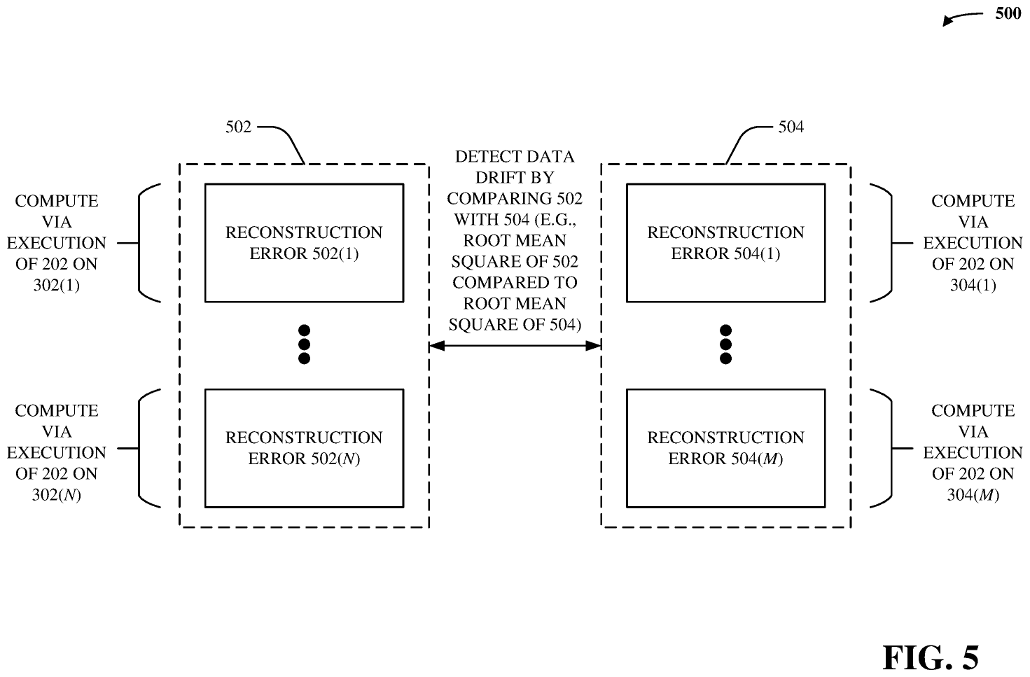

Now, consider FIG. 5. In various embodiments, the drift component 116 can generate a reconstruction error 502(1), by executing the deep learning autoencoder 202 on the sentence embedding collection 302(1). Likewise, in various aspects, the drift component 116 can generate a reconstruction error 502(n), by executing the deep learning autoencoder 202 on the sentence embedding collection 302(n). In various instances, the reconstruction error 502(1) to the reconstruction error 502(n) can collectively be referred to as a set of reconstruction errors 502. Note that the set of reconstruction errors 502 can be considered as indicating how well or how poorly the deep learning autoencoder 202 was able to condense and reconstruct the sentence embeddings corresponding to the set of training unstructured text reports 106.

Furthermore, in various cases, the drift component 116 can generate a reconstruction error 504(1), by executing the deep learning autoencoder 202 on the sentence embedding collection 304(1). Similarly, in various aspects, the drift component 116 can generate a reconstruction error 504(m), by executing the deep learning autoencoder 202 on the sentence embedding collection 304(m). In various instances, the reconstruction error 504(1) to the reconstruction error 504(m) can collectively be referred to as a set of reconstruction errors 504. Note that the set of reconstruction errors 504 can be considered as indicating how well or how poorly the deep learning autoencoder 202 was able to condense and reconstruct the sentence embeddings corresponding to the set of inferencing unstructured text reports 108.

In various cases, the drift component 116 can electronically generate the data drift determination 204, by comparing the set of reconstruction errors 502 to the set of reconstruction errors 504. As a non-limiting example, the drift component 116 can compute a root mean square of the set of reconstruction errors 502, and the drift component 116 can likewise compute a root mean square of the set of reconstruction errors 504. Suppose that the root mean square of the set of reconstruction errors 504 differs by less than any suitable threshold margin from the root mean square of the set of reconstruction errors 502. In such case, the data drift determination 204 can be any suitable electronic data indicating that the set of inferencing unstructured text reports 108 is sufficiently similar to the set of training unstructured text reports 106. In other words, the data drift determination 204 in such case can indicate that the set of inferencing unstructured text reports 108 has not drifted excessively far from the set of training unstructured text reports 106. In contrast, suppose that the root mean square of the set of reconstruction errors 504 differs by more than any suitable threshold margin from the root mean square of the set of reconstruction errors 502. In such case, the data drift determination 204 can be any suitable electronic data indicating that the set of inferencing unstructured text reports 108 is not sufficiently similar to the set of training unstructured text reports 106. That is, the data drift determination 204 in such case can indicate that the set of inferencing unstructured text reports 108 has drifted excessively far from the set of training unstructured text reports 106.

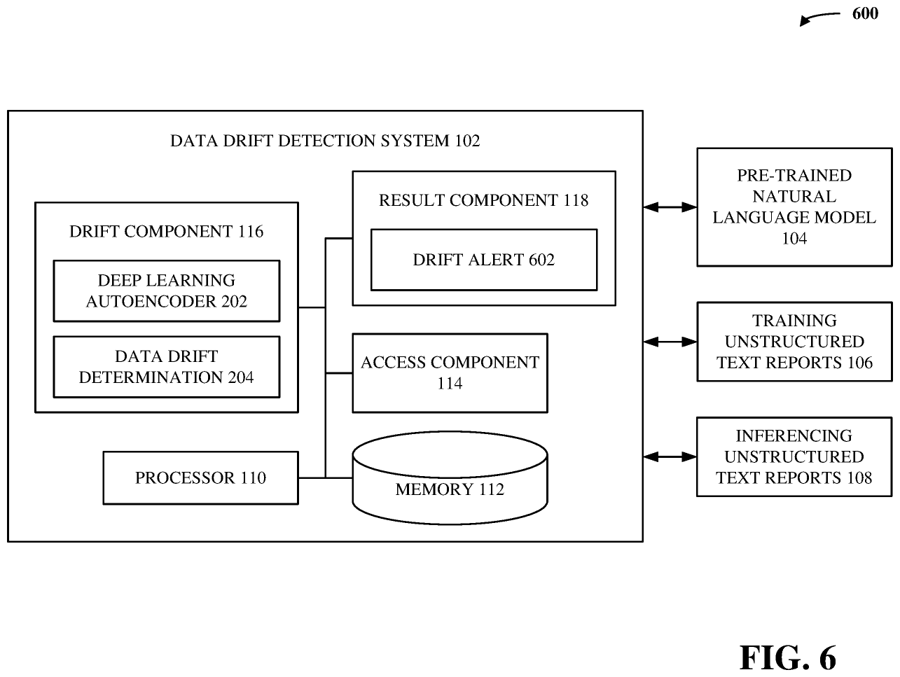

FIG. 6 illustrates a block diagram of an example, non-limiting system 600 including a drift alert that can facilitate data drift detection for unstructured texts via deep learning autoencoders in accordance with one or more embodiments described herein. As shown, the system 600 can, in some cases, comprise the same component as the system 200, and can further comprise a drift alert 602.

In various embodiments, the result component 118 can electronically generate the drift alert 602 based on the data drift determination 204. As a non-limiting example, suppose that the data drift determination 204 indicates that the set of inferencing unstructured text reports 108 has not drifted excessively far from the set of training unstructured text reports 106. In such case, the drift alert 602 can be any suitable electronic notification or message that indicates that excessive data drift is not detected between the set of inferencing unstructured text reports 108 and the set of training unstructured text reports 106. Accordingly, the drift alert 602 can further indicate that the pre-trained natural language model 104 can be confidently or reliably executed on the set of inferencing unstructured text reports 108 (e.g., the pre-trained natural language model 104 can confidently analyze the set of inferencing unstructured text reports 108 without first undergoing retraining or fine-tuning). In such case, the drift alert 602 can further comprise a recommendation to execute the pre-trained natural language model 104 on each of the set of inferencing unstructured text reports 108. Indeed, in some cases, the result component 118 can even electronically command, instruct, or otherwise cause the pre-trained natural language model 104 to be executed on each of the set of inferencing unstructured text reports 108.

As another non-limiting example, suppose that the data drift determination 204 instead indicates that the set of inferencing unstructured text reports 108 has drifted excessively far from the set of training unstructured text reports 106. In such case, the drift alert 602 can be any suitable electronic notification or message that indicates that excessive data drift is detected between the set of inferencing unstructured text reports 108 and the set of training unstructured text reports 106. Accordingly, the drift alert 602 can further indicate that the pre-trained natural language model 104 cannot be confidently or reliably executed on the set of inferencing unstructured text reports 108 (e.g., the pre-trained natural language model 104 cannot confidently analyze the set of inferencing unstructured text reports 108 without first undergoing retraining or fine-tuning). In such case, the drift alert 602 can further comprise a recommendation against executing the pre-trained natural language model 104 on each of the set of inferencing unstructured text reports 108. Indeed, in some cases, the result component 118 can even electronically prevent, prohibit, or forbid the pre-trained natural language model 104 from being executed on each of the set of inferencing unstructured text reports 108.

In various aspects, the result component 118 can electronically render, on any suitable electronic display (e.g., computer screen, computer monitor), the drift alert 602. In various other aspects, the result component 118 can electronically transmit, to any other suitable computing device, the drift alert 602.

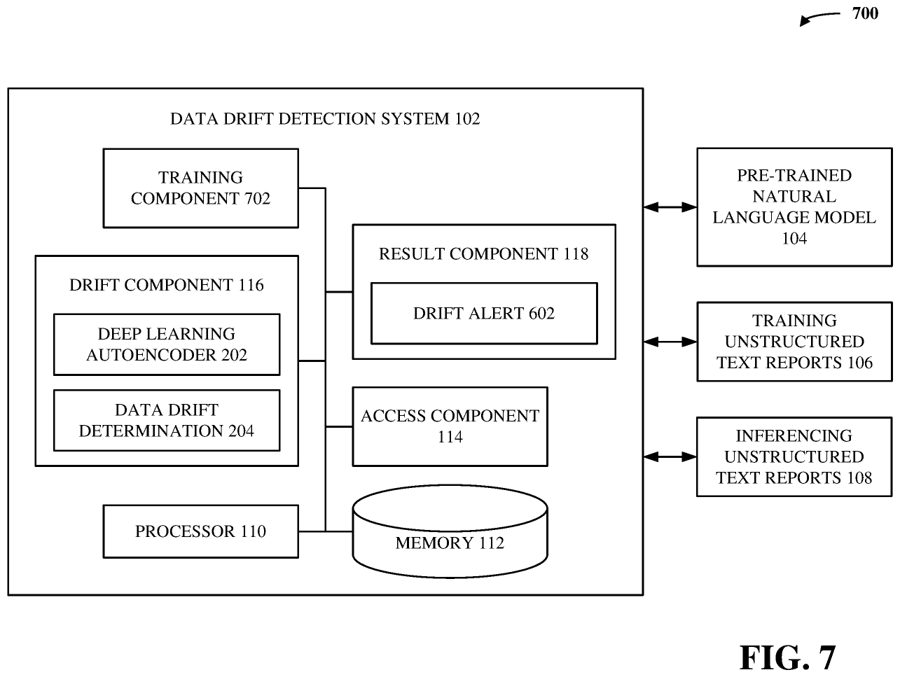

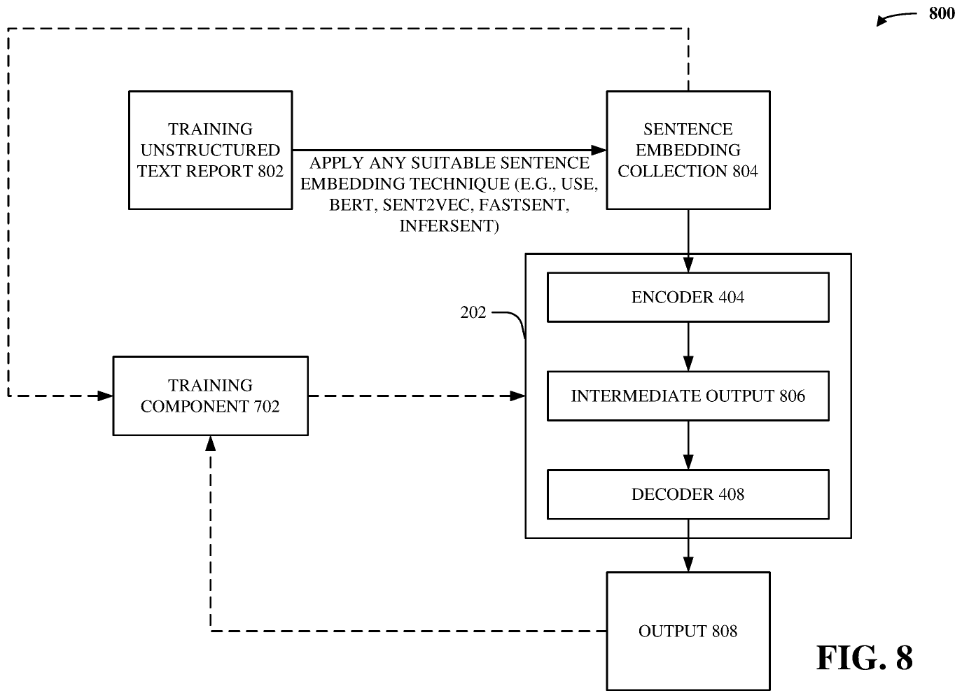

In order for the accuracy of the condensation-reconstruction performance of the deep learning autoencoder 202 to reliably indicate whether or not the pre-trained natural language model 104 can be confidently executed on the set of inferencing unstructured text reports 108, the deep learning autoencoder 202 can first be trained on the same data that the pre-trained natural language model 104 was trained on. That is, the deep learning autoencoder 202 can first be trained on the set of training unstructured text reports 106, as described with respect to FIGS. 7-8.

FIG. 7 illustrates a block diagram of an example, non-limiting system 700 including a training component that can facilitate data drift detection for unstructured texts via deep learning autoencoders in accordance with one or more embodiments described herein. As shown, the system 700 can, in some cases, comprise the same components as the system 600, and can further comprise a training component 702.

In various embodiments, the training component 702 can perform unsupervised training of the deep learning autoencoder 202 with respect to the set of training unstructured text reports 106. Non-limiting aspects are described with respect to FIG. 8.

FIG. 8 illustrates an example, non-limiting block diagram showing how a deep learning autoencoder can be trained in accordance with one or more embodiments described herein.

Prior to beginning training, the training component 702 can initialize in any suitable fashion (e.g., random initialization) the trainable internal parameters (e.g., weight matrices, bias values, convolutional kernels) of the deep learning autoencoder 202 (e.g., of the encoder 404 and of the decoder 408).

In various aspects, the training component 702 can select any suitable training unstructured text report from the set of training unstructured text reports 106. Such selected training unstructured text report can be referred to as a training unstructured text report 802.

In various instances, the training component 702 can generate a sentence embedding collection 804, by applying any suitable sentence embedding technique (e.g., USE, BERT, Sent2Vec, FastSent, InferSent) to the training unstructured text report 802.

In various cases, the training component 702 can execute the deep learning autoencoder 202 on the sentence embedding collection 804. In various aspects, this can cause the deep learning autoencoder 202 to produce an output 808.

More specifically, the training component 702 can feed the sentence embedding collection 804 to the input layer of the encoder 404. In various cases, the sentence embedding collection 804 can complete a forward pass through the one or more hidden layers of the encoder 404. Accordingly, the output layer of the encoder 404 can compute or calculate an intermediate output 806 based on activation maps or feature maps produced by the one or more hidden layers of the encoder 404.

Note that, in various cases, the format, size, or dimensionality of the intermediate output 806 can be controlled or otherwise determined by the number, arrangement, or sizes of neurons or of other internal parameters (e.g., convolutional kernels) that are contained in or that otherwise make up the output layer (or any other layers) of the encoder 404. Thus, the intermediate output 806 can be forced to have any desired format, size, or dimensionality by adding, removing, or otherwise adjusting neurons or other internal parameters to, from, or within the output layer (or any other layers) of the encoder 404. Accordingly, in various aspects, the intermediate output 806 can be forced to have a smaller (e.g., in some cases, one or more orders of magnitude smaller) format, size, or dimensionality than the sentence embedding collection 804. In such case, the intermediate output 806 can be considered as a condensed latent vector that the encoder 404 has predicted or inferred for the sentence embedding collection 804.

Furthermore, note that, if the encoder 404 has so far undergone no or little training, then the intermediate output 806 can be highly inaccurate (e.g., can fail to properly capture the substantive content of the sentence embedding collection 804).

Now, the intermediate output 806 can be fed to the input layer of the decoder 408. In various cases, the intermediate output 806 can complete a forward pass through the one or more hidden layers of the decoder 408. Accordingly, the output layer of the decoder 408 can compute or calculate the output 808 based on activation maps or feature maps produced by the one or more hidden layers of the decoder 408.

Note that, in various cases, the format, size, or dimensionality of the output 808 can be controlled or otherwise determined by the number, arrangement, or sizes of neurons or of other internal parameters (e.g., convolutional kernels) that are contained in or that otherwise make up the output layer (or any other layers) of the decoder 408. Thus, the output 808 can be forced to have any desired format, size, or dimensionality by adding, removing, or otherwise adjusting neurons or other internal parameters to, from, or within the output layer (or any other layers) of the decoder 408. Accordingly, in various aspects, the output 808 can be forced to have the same format, size, or dimensionality as the sentence embedding collection 804. In such case, the output 808 can be considered as a reconstructed version of the sentence embedding collection 804 that the decoder 408 has predicted or inferred based on the intermediate output 806.

Furthermore, note that, if the decoder 408 has so far undergone no or little training, then the output 808 can be highly inaccurate (e.g., can be very different from the sentence embedding collection 804).

In various aspects, the training component 702 can compute an error or loss (e.g., MAE, MSE, cross-entropy error, Euclidean distance) between the output 808 and the sentence embedding collection 804. In various instances, as shown, the training component 702 can incrementally update the trainable internal parameters of the deep learning autoencoder 202 (e.g., of both the encoder 404 and the decoder 408), by performing backpropagation (e.g., stochastic gradient descent) driven by the computed error or loss.

In various cases, the training component 702 can repeat the above-described training procedure for any suitable number of training unstructured text reports (e.g., for all of the set of training unstructured text reports 106). This can ultimately cause the trainable internal parameters of the encoder 404 to become iteratively optimized for accurately condensing inputted sentence embedding collections into latent vectors, and this can also ultimately cause the trainable internal parameters of the decoder 408 to become iteratively optimized for accurately reconstructing sentence embedding collections based on inputted latent vectors. In other words, such training can cause the deep learning autoencoder 202 to learn how to accurately condense and subsequently reconstruct inputted sentence embedding collections. In various aspects, the training component 702 can implement any suitable training batch sizes, any suitable training termination criteria, or any suitable error, loss, or objective functions.

Note that, because the deep learning autoencoder 202 can be trained on the same data that the pre-trained natural language model 104 was trained on, the deep learning autoencoder 202 and the pre-trained natural language model 104 can be expected to accurately analyze the same data as each other and to inaccurately analyze the same data as each other. Accordingly, if the deep learning autoencoder 202 inaccurately condenses and reconstructs the embeddings of any given unstructured text reports, it can be expected that the pre-trained natural language model 104 would not be able to confidently or reliably perform the inferencing task on those given unstructured text reports. Thus, the deep learning autoencoder 202 can be leveraged or exploited to detect data drift for the pre-trained natural language model 104.

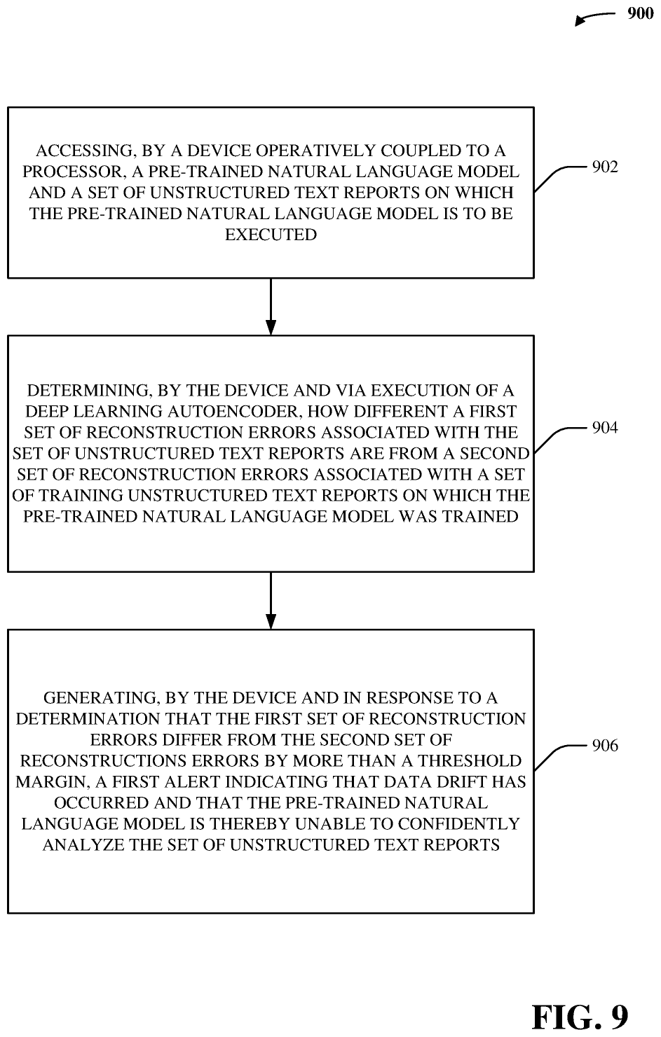

FIG. 9 illustrates a flow diagram of an example, non-limiting computer-implemented method 900 that can facilitate data drift detection for unstructured texts via deep learning autoencoders in accordance with one or more embodiments described herein. In various cases, the data drift detection system 102 can facilitate the computer-implemented method 900.

In various embodiments, act 902 can include accessing, by a device (e.g., via 114) operatively coupled to a processor (e.g., 110), a pre-trained natural language model (e.g., 104) and a set of unstructured text reports (e.g., 108) on which the pre-trained natural language model is to be executed.

In various aspects, act 904 can include determining, by the device (e.g., via 116) and via execution of a deep learning autoencoder (e.g., 202), how different a first set of reconstruction errors (e.g., 504) associated with the set of unstructured text reports are from a second set of reconstruction errors (e.g., 502) associated with a set of training unstructured text reports (e.g., 106) on which the pre-trained natural language model was trained.

In various instances, act 906 can include generating, by the device (e.g., via 118) and in response to a determination (e.g., 204) that the first set of reconstruction errors differ from the second set of reconstruction errors by more than a threshold margin, a first alert (e.g., 602) indicating that data drift has occurred and that the pre-trained natural language model is thereby unable to confidently analyze the set of unstructured text reports.

Although not explicitly shown in FIG. 9, the computer-implemented method 900 can include: generating, by the device (e.g., via 118) and in response to a determination (e.g., alternate version of 204) that the first set of reconstruction errors differ from the second set of reconstruction errors by less than the threshold margin, a second alert (e.g., alternate version of 602) indicating that data drift has not occurred and that the pre-trained natural language model is thereby able to confidently analyze the set of unstructured text reports.

Although not explicitly shown in FIG. 9, the computer-implemented method 900 can include: training, by the device (e.g., via 702), the deep learning autoencoder on the set of training unstructured text reports. In various aspects, for a first training unstructured text report (e.g., 802) in the set of training unstructured text reports, the device (e.g., via 702) can: randomly initialize trainable internal parameters of the deep learning autoencoder; convert the first training unstructured text report into a collection of sentence embeddings (e.g., 804); execute the deep learning autoencoder on the collection of sentence embeddings, wherein an encoder portion (e.g., 404) of the deep learning autoencoder receives the collection of sentence embeddings and produces a dimensionally-reduced latent vector (e.g., 806), and wherein a decoder portion (e.g., 408) of the deep learning autoencoder receives the dimensionally-reduced latent vector and produces a collection of reconstructed sentence embeddings (e.g., 808); compute an error between the collection of sentence embeddings and the collection of reconstructed sentence embeddings; and update, via backpropagation, the trainable internal parameters of the deep learning autoencoder based on the error. In various instances, the device (e.g., via 702) can convert the first training unstructured text report into the collection of sentence embeddings, via a universal sentence encoding technique.

Although not explicitly shown in FIG. 9, the first set of reconstruction errors and the second set of reconstruction errors can be based on Euclidean distance computations.

Although not explicitly shown in FIG. 9, the deep learning autoencoder can comprise a long short-term memory architecture.

Various embodiments described herein can include a computer program product for facilitating data drift detection for unstructured text via deep learning autoencoders. In various aspects, the computer program product can comprise a non-transitory computer-readable memory (e.g., 112) having program instructions embodied therewith. In various instances, the program instructions can be executable by a processor (e.g., 110) to cause the processor to: access a pre-trained clinical natural language model (e.g., 104) and a set of unstructured clinical text reports (e.g., 108) on which the pre-trained clinical natural language model is to be executed; determine, via execution of a deep learning autoencoder (e.g., 202), how different a first set of reconstruction errors (e.g., 504) associated with the set of unstructured clinical text reports are from a second set of reconstruction errors (e.g., 502) associated with a set of training unstructured clinical text reports (e.g., 106) on which the pre-trained clinical natural language model was trained; and generate, in response to a determination (e.g., 204) that the first set of reconstruction errors differ from the second set of reconstruction errors by more than a threshold margin, a first alert (e.g., 602) indicating that data drift has occurred and that the pre-trained clinical natural language model is thereby unable to confidently analyze the set of unstructured clinical text reports.

In various aspects, the program instructions can be further executable to cause the processor to: generate, in response to a determination (e.g., alternate version of 204) that the first set of reconstruction errors differ from the second set of reconstruction errors by less than the threshold margin, a second alert (e.g., alternate version of 602) indicating that data drift has not occurred and that the pre-trained clinical natural language model is thereby able to confidently analyze the set of unstructured clinical text reports.

In various aspects, the program instructions can be further executable to cause the processor to: train the deep learning autoencoder on the set of training unstructured clinical text reports (e.g., as described with respect to FIGS. 7-8).

The present inventors experimentally verified various technical benefits of various embodiments described herein. Indeed, the present inventors conducted various experiments in which a natural language model was configured to perform an inferencing task on medical text reports, and where the natural language model was specifically trained on radiology reports. During such experiments, a deep learning autoencoder was trained as described herein on those same radiology reports. After such training, the deep learning autoencoder was executed on those radiology reports and was also executed on various pathology reports (e.g., a pathology report can be considered as a substantively different type of medical text report than a radiology report). Such execution yielded reconstruction errors associated with those radiology reports and other reconstruction errors associated with the pathology reports. The reconstruction errors associated with the radiology reports were statistically significantly lower than those associated with the pathology reports. These experiments demonstrate that the deep learning autoencoder learned how to proficiently distinguish medical reports that it encountered during training from those that it did not encounter during training. In other words, these experiments verify that the deep learning autoencoder was able to be effectively leveraged for data drift detection.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

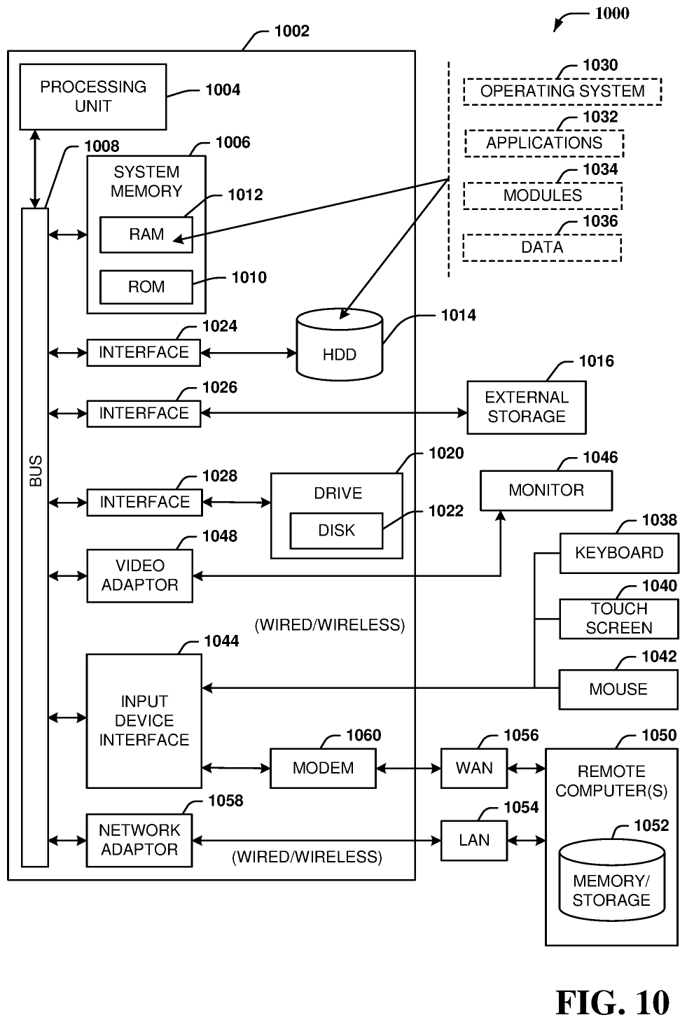

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

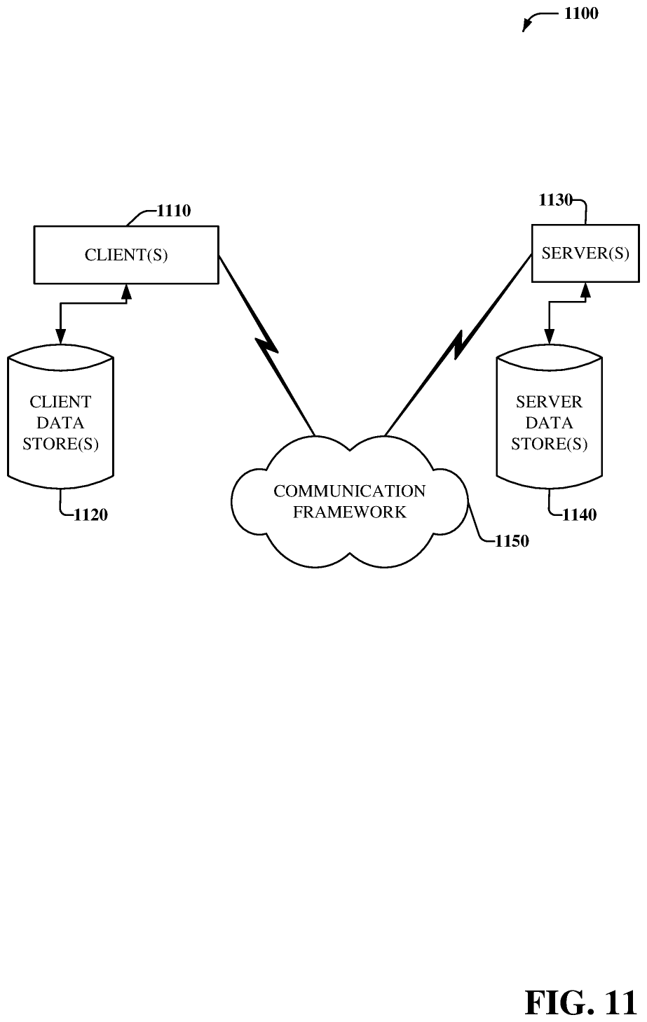

FIG. 11 is a schematic block diagram of a sample computing environment 1100 with which the disclosed subject matter can interact. The sample computing environment 1100 includes one or more client(s) 1110. The client(s) 1110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
an access component that accesses a pre-trained natural language model and a set of unstructured text reports on which the pre-trained natural language model is to be executed;
a drift component that determines, via execution of a deep learning autoencoder, how different a first set of reconstruction errors associated with the set of unstructured text reports are from a second set of reconstruction errors associated with a set of training unstructured text reports on which the pre-trained natural language model was trained; and
a result component that generates, in response to a determination that the first set of reconstruction errors differ from the second set of reconstruction errors by more than a threshold margin, a first alert indicating that data drift has occurred and that the pre-trained natural language model is thereby unable to confidently analyze the set of unstructured text reports.

2. The system of claim 1, wherein the result component generates, in response to a determination that the first set of reconstruction errors differ from the second set of reconstruction errors by less than the threshold margin, a second alert indicating that data drift has not occurred and that the pre-trained natural language model is thereby able to confidently analyze the set of unstructured text reports.

3. The system of claim 1, wherein the computer-executable components further comprise:
a training component that trains the deep learning autoencoder on the set of training unstructured text reports.

4. The system of claim 3, wherein, for a first training unstructured text report in the set of training unstructured text reports, the training component:
randomly initializes trainable internal parameters of the deep learning autoencoder;
converts the first training unstructured text report into a collection of sentence embeddings;
executes the deep learning autoencoder on the collection of sentence embeddings, wherein an encoder portion of the deep learning autoencoder receives the collection of sentence embeddings and produces a dimensionally-reduced latent vector, and wherein a decoder portion of the deep learning autoencoder receives the dimensionally-reduced latent vector and produces a collection of reconstructed sentence embeddings;
computes an error between the collection of sentence embeddings and the collection of reconstructed sentence embeddings; and
updates, via backpropagation, the trainable internal parameters of the deep learning autoencoder based on the error.

5. The system of claim 4, wherein the training component converts the first training unstructured text report into the collection of sentence embeddings, via a universal sentence encoding technique.

6. The system of claim 1, wherein the first set of reconstruction errors and the second set of reconstruction errors are based on Euclidean distance computations.

7. The system of claim 1, wherein the deep learning autoencoder comprises a long short-term memory architecture.

8. A computer-implemented method, comprising:
accessing, by a device operatively coupled to a processor, a pre-trained natural language model and a set of unstructured text reports on which the pre-trained natural language model is to be executed;
determining, by the device and via execution of a deep learning autoencoder, how different a first set of reconstruction errors associated with the set of unstructured text reports are from a second set of reconstruction errors associated with a set of training unstructured text reports on which the pre-trained natural language model was trained; and
generating, by the device and in response to a determination that the first set of reconstruction errors differ from the second set of reconstruction errors by more than a threshold margin, a first alert indicating that data drift has occurred and that the pre-trained natural language model is thereby unable to confidently analyze the set of unstructured text reports.

9. The computer-implemented method of claim 8, further comprising:
generating, by the device and in response to a determination that the first set of reconstruction errors differ from the second set of reconstruction errors by less than the threshold margin, a second alert indicating that data drift has not occurred and that the pre-trained natural language model is thereby able to confidently analyze the set of unstructured text reports.

10. The computer-implemented method of claim 8, further comprising:
training, by the device, the deep learning autoencoder on the set of training unstructured text reports.

11. The computer-implemented method of claim 10, wherein, for a first training unstructured text report in the set of training unstructured text reports, the device:
randomly initializes trainable internal parameters of the deep learning autoencoder;
converts the first training unstructured text report into a collection of sentence embeddings;
executes the deep learning autoencoder on the collection of sentence embeddings, wherein an encoder portion of the deep learning autoencoder receives the collection of sentence embeddings and produces a dimensionally-reduced latent vector, and wherein a decoder portion of the deep learning autoencoder receives the dimensionally-reduced latent vector and produces a collection of reconstructed sentence embeddings;
computes an error between the collection of sentence embeddings and the collection of reconstructed sentence embeddings; and
updates, via backpropagation, the trainable internal parameters of the deep learning autoencoder based on the error.

12. The computer-implemented method of claim 11, wherein the device converts the first training unstructured text report into the collection of sentence embeddings, via a universal sentence encoding technique.

13. The computer-implemented method of claim 8, wherein the first set of reconstruction errors and the second set of reconstruction errors are based on Euclidean distance computations.

14. The computer-implemented method of claim 8, wherein the deep learning autoencoder comprises a long short-term memory architecture.

15. A computer program product for facilitating data drift detection for unstructured texts via deep learning autoencoders, the computer program product comprising a non-transitory computer-readable memory having program instructions embodied therewith, the program instructions executable by a processor to cause the processor to:
access a pre-trained clinical natural language model and a set of unstructured clinical text reports on which the pre-trained clinical natural language model is to be executed;
determine, via execution of a deep learning autoencoder, how different a first set of reconstruction errors associated with the set of unstructured clinical text reports are from a second set of reconstruction errors associated with a set of training unstructured clinical text reports on which the pre-trained clinical natural language model was trained; and
generate, in response to a determination that the first set of reconstruction errors differ from the second set of reconstruction errors by more than a threshold margin, a first alert indicating that data drift has occurred and that the pre-trained clinical natural language model is thereby unable to confidently analyze the set of unstructured clinical text reports.

16. The computer program product of claim 15, wherein the program instructions are further executable to cause the processor to:
generate, in response to a determination that the first set of reconstruction errors differ from the second set of reconstruction errors by less than the threshold margin, a second alert indicating that data drift has not occurred and that the pre-trained clinical natural language model is thereby able to confidently analyze the set of unstructured clinical text reports.

17. The computer program product of claim 15, wherein the program instructions are further executable to cause the processor to:
train the deep learning autoencoder on the set of training unstructured clinical text reports.

18. The computer program product of claim 17, wherein, for a first training unstructured clinical text report in the set of training unstructured clinical text reports, the processor:
randomly initializes trainable internal parameters of the deep learning autoencoder;
converts the first training unstructured clinical text report into a collection of sentence embeddings;
executes the deep learning autoencoder on the collection of sentence embeddings, wherein an encoder portion of the deep learning autoencoder receives the collection of sentence embeddings and produces a dimensionally-reduced latent vector, and wherein a decoder portion of the deep learning autoencoder receives the dimensionally-reduced latent vector and produces a collection of reconstructed sentence embeddings;
computes an error between the collection of sentence embeddings and the collection of reconstructed sentence embeddings; and
updates, via backpropagation, the trainable internal parameters of the deep learning autoencoder based on the error.

19. The computer program product of claim 18, wherein the processor converts the first training unstructured clinical text report into the collection of sentence embeddings, via a universal sentence encoding technique.

20. The computer program product of claim 15, wherein the first set of reconstruction errors and the second set of reconstruction errors are based on Euclidean distance computations.
